(19) United States
(12) Patent Application Publication
(10) Pub. No.: US 2004/0076342 A1
(43) Pub. Date: Apr. 22, 2004

(54) Automatic image placement and linking

(75) Inventors: Gregory J. Wolff, Redwood City, CA (US); Bradley J. Rhodes, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ricoh Company, Ltd., Tokyo (JP)

(21) Appl. No.: 10/028,997

(22) Filed: Dec. 20, 2001

(51) Int. Cl. G06K 9/32

(52) U.S. Cl. 382/294

(57) ABSTRACT

Techniques for generating a customized digital image using one or more digital images. According to an embodiment of the present invention, the customized image generated by the present invention is composed using one or more digital images accessible to an image generation system. The positions of the one or more digital images in the customized image are determined by another digital image accessible to the image generation system.

### BACKGROUND OF THE INVENTION

The present invention relates to the field of digital images, and more particularly to techniques for generating a customized digital image using one or more digital images.

The availability of images in digital format has grown rapidly following the widespread use of devices such as digital cameras, scanners, copiers, and other devices that are capable of producing digital images. With the widespread proliferation of digital images, the need for tools that are capable of handling and manipulating digital images is ever increasing.

Several tools and applications are presently available that allow users to manipulate digital images to create customized digital images as desired by the user. Examples of such applications include various software packages (e.g., Adobe® Photoshop®) provided by Adobe Systems, Inc. of San Jose, Calif., and others. Apart from being quite expensive, most of the conventional image processing applications require that the user be well versed in the use of computers and the use of the image processing application. Since many of these applications have steep learning curves, novice users cannot generally easily use them. Further, even if the user is well versed in the use of these applications, in order to use the applications, the user has to have access to a computer system running the software applications. This may not always be possible given the expensive costs associated with these applications. Also, a computer system may not be available at the time and place that the digital images are taken.

Based upon the above, there is a need for simplified techniques that enable users to create customized images.

### BRIEF SUMMARY OF THE INVENTION

The present invention provides techniques for generating a customized digital image using one or more digital images. According to an embodiment of the present invention, the customized image generated by the present invention is composed of one or more digital images accessible to an image generation system. The positions of the one or more images in the customized image are determined by another digital image accessible to the image generation system.

According to an embodiment of the present invention, techniques are provided for generating a customized digital image. In this embodiment, the image generation system (IGS) receives a first digital image. The IGS then determines one or more placement regions from the first digital image, each placement region of the one or more placement regions identifying a location on the first digital image for placing a digital image from a first set of digital images. The IGS then identifies, for each placement region of the one or more placement regions, a digital image from the first set of digital images to be placed in the placement region. For each placement region of the one or more placement regions, the IGS places a digital image from the first set of digital images identified for the placement region in the placement region to generate the customized digital image.

According to an embodiment of the present invention, the first set of digital images comprises digital image copies of a second set of digital images, and the IGS creates a link between at least one digital image in the customized digital image and the corresponding digital image in the second set of digital images. The IGS can then receive a user input indicating selection of the at least one digital image in the customized digital image, and retrieve the digital image corresponding to the at least one digital image from the second set of digital images.

According to another embodiment of the present invention, techniques are provided for generating a customized digital image. In this embodiment, the IGS receives a signal comprising digital signals representative of a plurality of digital images. The IGS determines a template image from the plurality of digital image, and determines one or more placement regions from the template image, each placement region of the one or more placement regions identifying a location on the template image for receiving a digital image from the plurality of digital images. The IGS identifies, for each placement region of the one or more placement regions, a digital image from the plurality of digital images to be placed in the placement region, and for each placement region of the one or more placement regions, the IGS places a copy of a digital image from the plurality of digital images identified for the placement region in the placement region to generate the customized digital image.

According to yet another embodiment of the present invention, techniques are provided for generating a customized digital image. In this embodiment the present invention receives a first digital image, analyzes the first digital image to determine a first placement region on the first digital image for placing a second digital image, and places the second digital image in the first placement region on the first digital image to generate the customized digital image.

According to an embodiment of the present invention, techniques are provided for generating a customized digital image using a digital camera. In this embodiment, a digital camera is used to capture one or more images and a template image by scanning a paper medium. The digital camera then determines one or more placement regions from the template image, each placement region of the one or more placement regions identifying a location on the template image for placing an image from the one or more images captured using the digital camera. The digital camera identifies, for each placement region of the one or more placement regions, an image from the one or more images to be placed in the placement region. For each placement region of the one or more placement regions, the digital camera places a copy of an image from the one or more images identified for the placement region in the placement region to generate the customized digital image.

According to another embodiment of the present invention, techniques are provided for generating a customized digital image using a digital camera. In this embodiment, a user may capture one or more images and a template image using a digital camera. The template image comprises one or more bounded regions, each bounded region of the one or more bounded regions identifying a location on the template image for placing an image of the one or more images captured using the digital camera. The user then obtains a customized image from the digital camera, wherein the customized digital image is generated by placing a copy of at least one image from the one or more images in at least one bounded region on the template image.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of system for generating customized images according to an embodiment of the present invention;

FIGS. 2A-2G depict simplified examples of template images according to an embodiment of the present invention;

FIG. 3 is a simplified high-level flowchart depicting a method of generating a customized digital image according to an embodiment of the present invention;

FIG. 4A depicts simplified images received by an IGS according to an embodiment of the present invention; and

FIG. 4B depicts a simplified customized image generated by an IGS according to an embodiment of the present invention.

### DETAILED DESCRIPTION OF THE INVENTION

The present invention provides techniques for generating a customized digital image using one or more digital images. According to an embodiment of the present invention, the customized image generated is composed using one or more digital images (hereinafter referred to as “candidate images”) accessible to an image generation system. The positions of the one or more candidate images in the customized image are determined by another digital image (hereinafter referred to as the “template image”) accessible to the image generation system.

According to an embodiment of the present invention, the template image is used as a starting point for generating the customized digital image. The template image comprises marked regions (hereinafter referred to as “image placement regions”) that identify one or more locations where the one or more candidate digital images or copies thereof are to be placed while composing the customized digital image. Each image placement region on the template image specifies a location for receiving a candidate image or a copy thereof. According to an embodiment of the present invention, the image placement regions specified by the template image also determine the sizes of the candidate images in the customized image. According to an embodiment of the present invention, links are maintained between the digital images displayed in the customized digital image and the original candidate images that are used to compose the customized digital image such that the original candidate images can be retrieved from the customized digital image.

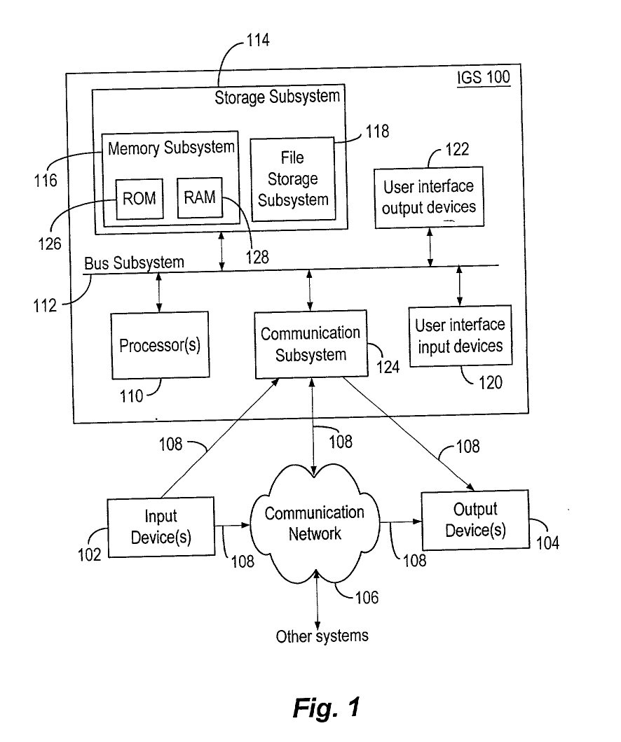

FIG. 1 is a simplified block diagram of system 100 (hereinafter referred to as “image generation system 100” or “IGS 100”) for generating customized images according to an embodiment of the present invention. As shown in FIG. 1, IGS 100 is coupled to input devices 102, output devices 104, and communication network 106 via communication links 108. It should be apparent that the configuration depicted in FIG. 1 is merely illustrative of an embodiment incorporating the present invention and does not limit the scope of the invention as recited in the claims. One of ordinary skill in the art would recognize other variations, modifications, and alternatives.

Communication links 108 that are used to connect IGS 100 to input devices 102, output devices 104, or communication network 106 may be of various types including hardwire links, optical links, satellite or other wireless communications links, wave propagation links, or any other mechanisms for communication of information. Various communication protocols may be used to facilitate communication of information via communication links 108. These communication protocols may include TCP/IP, HTTP protocols, extensible markup language (XML), wireless application protocol (WAP), protocols under development by industry standard organizations, vendor-specific protocols, customized protocols, and others.

Communication network 106 provides a mechanism allowing IGS 100 to communicate and exchange data and information with devices or systems coupled to communication network 106. These systems may include computer systems, input devices, output devices, and other systems. Communication network 106 may itself be comprised of many interconnected computer systems and communication links. While in one embodiment, communication network 106 is the Internet, in other embodiments, communication network 106 may be any suitable communication network including a local area network (LAN), a wide area network (WAN), a wireless network, an intranet, a private network, a public network, a switched network, an enterprise network, a virtual private network, and the like.

According to an embodiment of the present invention, IGS 100 is configured to generate a customized image using one or more candidate digital images and a template digital image accessible to IGS 100. IGS 100 may receive the digital images to be used for generating the customized image from input devices 102 and/or from systems coupled to communication network 106. For example, according to an embodiment of the present invention, IGS 100 receives digital signals representative of the images from one or more input devices 102. The images, including the template image and one or more candidate images, may also be received by IGS 100 via user interface input devices of IGS 100. The customized digital image generated by IGS 100 may be stored by IGS 100 or may communicated to one or more output devices 104 or other systems or devices via communication network 106.

Input devices 102 may include a scanner, a digital camera, a video camera, or any other device that is capable of generating a digital image. Input devices 102 may also include readers capable of reading information stored on a computer readable storage medium such as a CD, a DVD, a floppy disk, and the like. Output devices 104 may include devices that are capable of outputting customized digital images generated by IGS 100. Examples of output devices include a display subsystem (e.g., a cathode ray tube (CRT), a flat-panel device such as a liquid crystal display (LCD), or a projection device, etc.), a printer, a fax machine, a photocopier, a machine that prints photographs, a device capable of printing images on a paper medium, and the like. Input devices 102 and output devices 104 may be directly coupled to IGS 100 or may be coupled to IGS 100 via communication network 106.

As shown in FIG. 1, IGS 100 includes at least one processor 110 that communicates with a number of subsystems via a bus subsystem 112. The subsystems may include a storage subsystem 114, comprising a memory subsystem 116 and a file storage subsystem 118, user interface input devices 120, user interface output devices 122, and a communication subsystem 124. The user interface input and output devices allow user interaction with IGS 100. A user may be a human user, a device, a process, another computer, and the like.

Communication subsystem 124 provides an interface that facilitates communication of information to and from IGS 100. For example, communication subsystem 124 provides an interface for receiving information from input devices 102 and other systems coupled to communication network 106 and for communicating information to output devices 104 and to systems coupled to communication network 106. According to an embodiment of the present invention, communication subsystem 124 is configured to receive digital signals representative of images to be used for generating the customized image. After a customized image has been generated by IGS 100, digital signals representing the customized image may be communicated from IGS 100 using communication subsystem 124.

Bus subsystem 112 provides a mechanism for letting the various components and subsystems of IGS 100 communicate with each other as intended. Although bus subsystem 112 is shown schematically as a single bus, alternative embodiments of the bus subsystem may utilize multiple buses.

User interface input devices 120 may include a keyboard, a mouse, trackball, touchpad, a graphics tablet, a scanner, a barcode scanner, a touchscreen incorporated into the display, audio input devices such as voice recognition systems, microphones, and other types of input devices. In general, use of the term “user interface input device” is intended to include all possible types of devices and ways to input information to IGS 100.

User interface output devices 122 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term “user interface output device” is intended to include all possible types of devices and ways to output information from IGS 100.

Storage subsystem 114 may be configured to store the basic programming modules and data constructs that provide the functionality of IGS 100. For example, according to an embodiment of the present invention, software modules implementing the functionality of the present invention may be stored in storage subsystem 114 of IGS 100. For example, software modules that facilitate generation of customized images according to the teachings of the present invention may be stored in storage subsystem 114. These software modules may be executed by processor(s) 110 of IGS 100.

Storage subsystem 114 may also provide a repository for storing images, including candidate images and template images, which are used to generate a customized image. Customized images generated by IGS 100 may also be stored in storage subsystem 114.

Storage subsystem 114 may comprise memory subsystem 116 and file storage subsystem 118. Memory subsystem 116 may include a number of memories including a main random access memory (RAM) 128 for storage of instructions and data during program execution and a read only memory (ROM) 126 in which fixed instructions are stored. File storage subsystem 118 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media. One or more of the drives may be located at remote locations on other connected computers.

IGS 100 depicted in FIG. 1 is intended only as a specific example for purposes of illustrating an embodiment of the present invention. Many other configurations of IGS 100 are possible having more or fewer components than IGS 100 depicted in FIG. 1. In alternative embodiments, IGS 100 may be incorporated as part of other systems or devices. For example, IGS 100 may be incorporated into a digital camera, a copy machine, a scanner, and the like.

As indicated above, the present invention provides techniques for generating a customized digital image based upon a template image and one or more candidate images. According to an embodiment of the present invention, the template image comprises information identifying locations, known as image placement regions, where the one or more candidate digital images or copies thereof are to be placed while composing the customized image. Further, according to another embodiment of the present invention, the size and manner in which each candidate image is displayed in the customized digital image may also be specified by the template digital image. According to an embodiment of the present invention, the template image also comprises information identifying the candidate images to be used for composing the customized image.

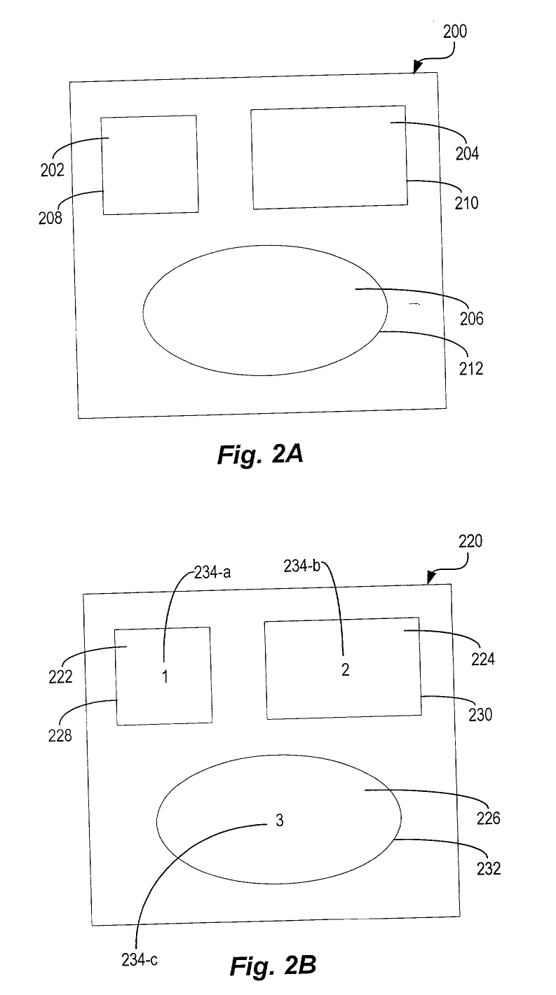

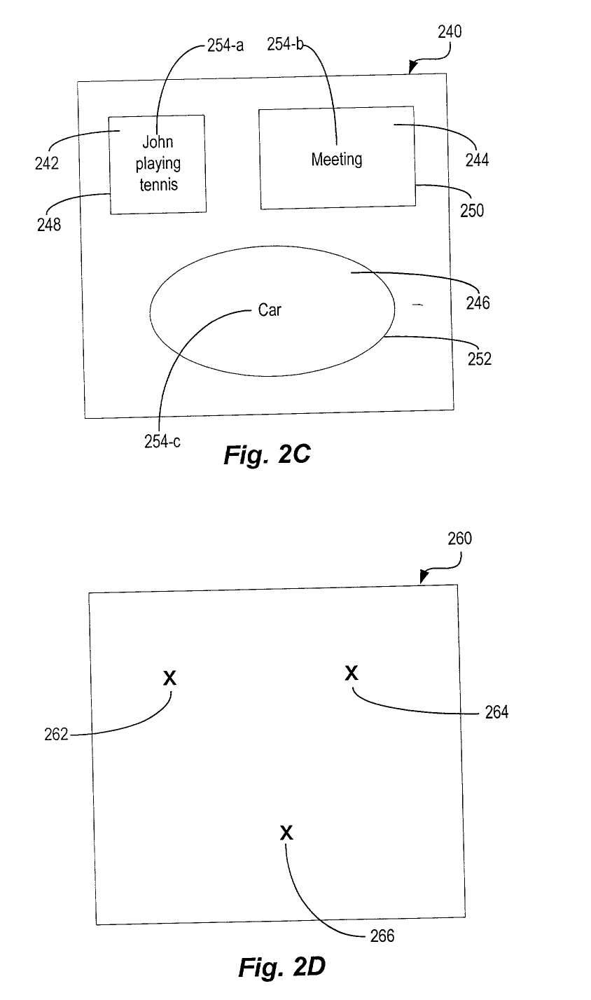

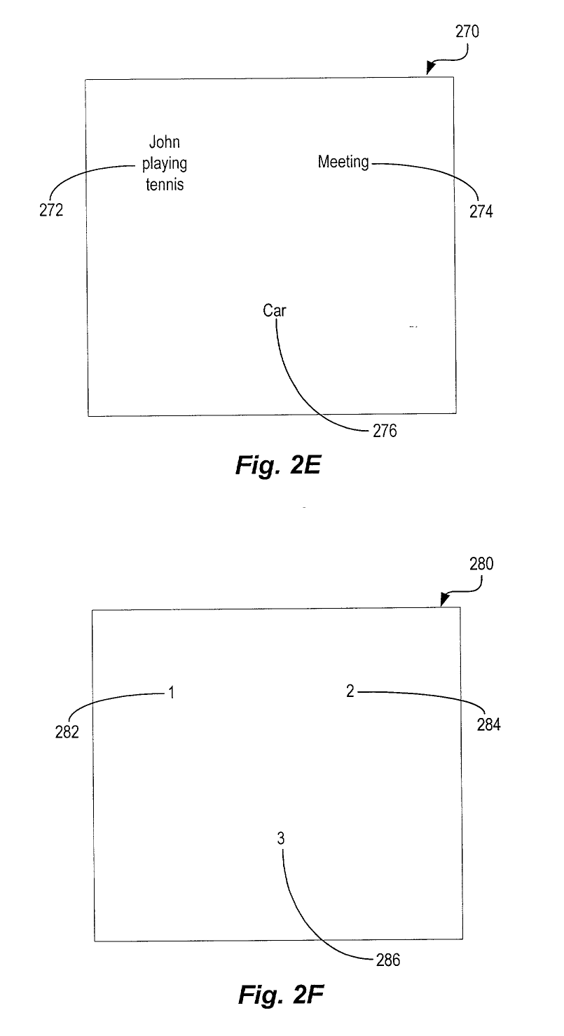

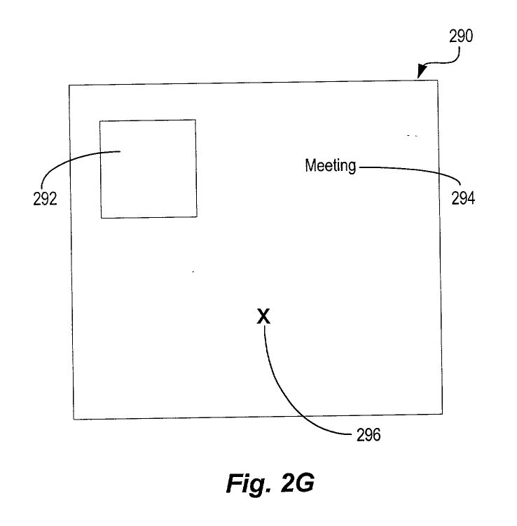

Various different techniques may be used for specifying the image placement regions on a template image. These techniques include the use of bounded regions, marks, glyphs, text, and other techniques. FIGS. 2A-2G depict simplified examples of template images according to an embodiment of the present invention.

FIG. 2A depicts a simplified template image 200 according to an embodiment of the present invention wherein image placements regions are indicated by bounded regions. As shown in FIG. 2A, three image placement regions 202, 204, and 206 are specified in template image 200 marked by square 208, rectangle 210, and oval 212. The bounded regions mark locations where candidate images or their copies are to be placed when composing the customized image. In addition to specifying the position of the images, the size of each bounded region also indicates the size of the candidate image to be placed in that bounded region. Accordingly, bounded regions 202, 204, and 206 indicate both the location and the size of images to be placed in the customized image. It should be apparent that various different bounded regions such as circles, hexagons, stars, asymmetrical bounded regions, and others may be used to specify the image placement regions.

FIG. 2B depicts another simplified template image 220 according to an embodiment of the present invention wherein image placements regions are indicated by bounded regions. Template image 220 comprises three image placement regions 222, 224, and 226 marked by square 228, rectangle 230, and oval 232 indicating locations where candidate images or their copies are to be placed when composing the customized image. Additionally, a number 234 is displayed in each bounded region. As explained below in further detail, the number associated with each bounded region is used to identify a particular candidate image to be placed in the bounded region corresponding to the number when composing the customized digital image. For example, number 234-a identifies a candidate image to be placed in image placement region 222, number 234-b identifies a candidate image to be placed in image placement region 224, and number 234-c identifies a candidate image to be placed in image placement region 226. In alternative embodiments, a number associated with a bounded region may be displayed in any location proximal to the bounded region on the template image.

FIG. 2C depicts another simplified template image 240 according to an embodiment of the present invention wherein image placements regions are indicated by bounded regions. Template image 240 comprises three image placement regions 242, 244, and 246 marked by square 248, rectangle 250, and oval 252 indicating locations where digital candidate images or their copies are to be placed when composing the customized image. Additionally, text information 254 is displayed in each bounded region. As explained below in further detail, text information 254 associated with each bounded region is used to identify a particular candidate image to be placed in the bounded region when composing the customized digital image. For example, text 254-a identifies a candidate image to be placed in image placement region 242, text 254-b identifies a candidate image to be placed in image placement region 244, and text 254-c identifies a candidate image to be placed in image placement region 246. In alternative embodiments, the text information associated with a bounded region may be displayed in any location proximal to the bounded region on the template image.

FIG. 2D depicts a simplified template image 260 according to an embodiment of the present invention wherein image placements regions are indicated by marks or glyphs displayed in the template image. As shown in FIG. 2D, template image 260 comprises three marks (or glyphs) 262, 264, and 266 indicating three image placement regions. Marks 262, 264, and 266 identify locations where candidate images or their copies are to be placed when composing the customized image. According to an embodiment of the present invention, for each mark, the candidate image included in the customized digital image is centered on the location of the mark. It should be apparent that various different marks or glyphs may be used to specify the image placement regions.

FIG. 2E depicts a simplified template image 270 according to an embodiment of the present invention wherein image placements regions are indicated by text displayed in the template image. Template image 270 comprises three text fragments 272, 274, and 276 that indicate three image placement regions. Each text fragment identifies a location where a candidate image or a copy thereof is to be placed when composing the customized image. According to an embodiment of the present invention, for each text fragment, the image included in the customized digital image may be centered on the location of the text fragment. It should be apparent that various different text fragments may be used to specify the image placement regions. As explained below in further detail, in addition to indicating the location where a candidate image is to be placed, each text fragment also comprises information that is used to identify a particular image to be placed in the image placement region associated with the text fragment when composing the customized digital image. It should be apparent that various different pieces of text or text fragments may be used to specify the image placement regions and to identify the candidate images to be used for composing the customized digital image. The text fragments may also be numbers (282, 284, and 286) as displayed in template image 280 depicted in FIG. 2F.

A combination of the techniques described above may also be used to specify image placement regions in a template image. FIG. 2G depicts a simplified template image 290 according to an embodiment of the present invention wherein image placements regions are indicated using a combination of different techniques. As shown in FIG. 2G, the image placement regions in template image 290 are marked by a bounded region 292, a text fragment 294, and a mark (or glyph) 296. It should be apparent that various combinations of techniques may be used in alternative embodiments of the present invention.

Template images 200, 220, 240, 260, 270, 280, and 290 depicted in FIGS. 2A, 2B, 2C, 2D, 2E, 2F, and 2G, respectively, are merely illustrative of examples of template images that may be used in accordance with the present invention. These examples are not intended to restrict the scope of the present invention as recited in the claims. It should be apparent that various other types of template images may also be used to specify image placement regions. A template image may comprise one or more image placement regions.

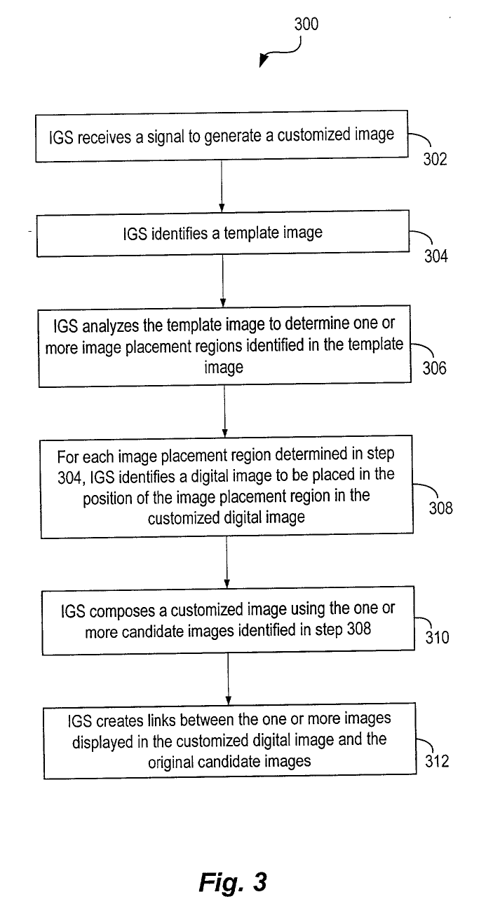

FIG. 3 is a simplified high-level flowchart 300 depicting a method of generating a customized digital image according to an embodiment of the present invention. Flowchart 300 depicted in FIG. 3 is merely illustrative of an embodiment incorporating the present invention and does not limit the scope of the invention as recited in the claims. One of ordinary skill in the art would recognize other variations, modifications, and alternatives.

As depicted in FIG. 3, the method is initiated when IGS 100 receives a signal requesting generation of a customized digital image (step 302). The signal may be received from various sources including from a user interacting with user input devices 120 of IGS 100, from an input device 102 coupled to IGS 100, from a system or device coupled IGS 100 via communication network 106, or from any other system or device capable of communicating a signal to IGS 100.

According to an embodiment of the present invention, the signal received in step 302 may comprise digital signals representative of digital images, including one or more template digital images and one or more candidate images, to be used for composing the customized digital image. Alternatively, the signal may comprise information identifying one or more digital images, including one or more template images and candidate images, to be used for composing the customized digital image. IGS 100 may then use the information identifying the images to access the images from a memory location accessible to IGS 100.

If the signal received in step 302 only identifies or comprises signals representing a template image or information identifying a template image, and does not identify one or more candidate images, the one or more candidate digital images to be used for composing the customized digital image may be identified from the template image itself (as described below in further detail). In this embodiment, the candidate images may be pre-stored in a memory location accessible to IGS 100.

In alternative embodiments of the present invention, the signal received in step 302 may comprise or identify multiple template images. In this embodiment, IGS 100 may automatically select a specific template image to be used for composing the customized digital image based upon the candidate images identified to be used for composing the customized digital image. For example, the signal received in step 302 may identify a first template image comprising two image placement regions and a second template image comprising three image placement regions. If the user has specified three candidate images to be used for composing the customized digital image, IGS 100 may automatically select the second template image as the template image to be used for composing the customized digital image.

In alternative embodiments of the present invention, the signal received in step 302 may only identify candidate images and may not identify a template image to be used for generating the customized digital image. In this embodiment, IGS 100 may automatically select a specific template image to be used for composing the customized digital image from template images accessible to IGS 100. According to an embodiment of the present invention, the template image to be used for composing the customized digital image is selected based upon the candidate images identified to be used for composing the customized digital image. For example, the signal received in step 302 may comprise three candidate images to be used for composing the customized digital image. IGS 100 may then automatically select a template image from a plurality of template images accessible to IGS 100 that is suited for composing a customized digital image using the three candidate images.

Various different techniques may be used for creating a template image and providing it to IGS 100. According to an embodiment of the present invention, the template image may be created by a user using a word processing application (e.g., MS-WORD provided by Microsoft Corporation of Redmond, Wash.), a drawing application, and the other like applications. In alternative embodiments, the template image may represent an image of a paper medium (e.g., a paper page) created by a user. The term “paper medium” as used in application is intended to include any tangible medium on which information may be printed, written, etched, embossed, etc. Examples of a paper medium include a paper page, a photograph, a whiteboard, etc.

For example, a user may use the following procedure to create a template image using bounded regions to indicate image placement regions (e.g., a template image such as template image 200 depicted in FIG. 2A). The user may use a writing instrument (such as a pen or pencil) to draw one or more bounded regions (e.g., a square, a rectangle, an oval, a circle, etc.) on a paper medium (e.g., a piece of paper) in locations desirable to the user. For each bounded region, the user may also write text information identifying a candidate image to be placed in the bounded region. The user may then generate a digital image of the paper medium using various different techniques. According to one technique, the user may take a photograph of the paper medium using a digital camera. A special button may be provided on the digital camera which when selected by the user indicates to the digital camera that the image captured by the digital camera is a template image. According to another technique, the user may scan the paper medium using a scanner, a copier, a fax machine, etc. The digital image of the paper medium generated as a result of taking the photograph, scanning, copying, etc. represents the template image and may then be provided to IGS 100. Features such as buttons, selection options, etc. may be provided on the devices used to generate the template image to identify a particular image as a template image. Various other techniques may also be used to generate a template image.

As indicated above, a user may specifically tag a particular image as the template image. Accordingly, the signal received in step 302 may comprise information identifying a particular image received via the signal as the template image. Information identifying an image as a template image may be included in the meta-date associated with the image and included in the signal received in step 302. As described above, various techniques may be provided allowing the user to tag a particular image as a template image. For example, if a digital camera is used to generate a template image, a user-selectable button or other selection option may be provided on the digital camera to indicate the presence of a template image. All images captured by the digital camera when the “template image button” is selected (or when the button is in the activated position) may be tagged as template images. Similar buttons or other selection options may be provided in other devices or systems used to capture digital images.

The signal received in step 302 may also contain other information or meta-data associated with one or more digital images received via the signal. For example, as described above, the meta-data may comprise information identifying a particular image as the template image. The signal may also comprise other information associated with the digital images received via the signal. For example, the meta-data associated with a digital image may include information indicating a time when the image was captured, a caption or other text associated with the image, a unique identifier associated with the image (e.g., a file name), text information identifying the contents of the digital image, the location where the image was taken, the date on which the image was taken, and other information that may be associated or is related to a digital image. The meta-data associated with a digital image may be used by IGS 100 to determine the identity of the image and to determine an image placement region where the image is to be placed when composing the customized digital image.

IGS 100 then identifies a template image to be used for generating the customized digital image based upon information included in the signal received in step 302 (step 304). Various different techniques may be used to identify a template image. According to an embodiment of the present invention, as described above, the user may manually identify a particular image as the template image. For example, when the user generates the template image (e.g., by using a digital camera), the user may associate information with the image indicating that the image is to be regarded as a template image. IGS 100 may then use the information associated with the image to identify it as a template image in step 304.

If the signal received in step 302 does not comprise information identifying a particular image as the template image, IGS 100 may determine a template image from the plurality of images received in step 302 by analyzing the digital signals representing the plurality of images. Various image processing and analysis techniques may be used to determine if an image is a template image based upon contents of the image. According to one technique, IGS 100 determines the template image from the plurality of images based upon the background of each image in the plurality of images. According to this technique, IGS 100 analyzes the background of each image and an image with the least variance is identified as the template image. It should be apparent that various other techniques known to those skilled in the art may also be used to determine the template image from the plurality of images.

In alternative embodiments, if the signal received in step 302 does not identify or comprise a template image or alternatively identifies or comprises multiple template images, IGS 100 may automatically select a specific template image to be used for composing the customized digital image based upon the candidate images identified to be used for composing the customized digital image (as described above). For example, if the signal received in step 302 comprises a first template image comprising two image placement regions and a second template image comprising three image placement regions and three candidate images to be used for composing the customized digital image, IGS 100 may automatically select the second template image as the template image to be used for composing the customized digital image. For example, if the signal received in step 302 comprises three candidate images to be used for composing the customized digital image, IGS 100 may then automatically select a template image from a plurality of template images accessible to IGS 100 that is suited for composing a customized digital image using the three candidate images.

After a template image has been identified, IGS 100 then analyzes the contents of the template image to identify one or more image placement regions located in the template image (step 306). Various different techniques may be used to identify the image placement regions from the template image. According to an embodiment of the present invention where bounded regions are used to identify image placement regions (e.g., template images 200, 220, and 240 depicted in FIGS. 2A, 2B, and 2C, respectively), IGS 100 may flood fill the background of the template image. IGS 100 may then detect any remaining closed regions in the template image that are above a threshold value. For example, according to an embodiment of the present invention, IGS 100 may detect closed regions that are larger than 200 mm². Closed regions exceeding the threshold value may then be identified as image placement regions. According to another embodiment of the present invention where image placement regions are identified using text fragments or marks (or glyphs) (e.g., templates 260, 270, and 280 depicted in FIGS. 2D, 2E, and 2F, respectively), IGS 100 may determine the marks or text printed in the template image by analyzing differences in contrast between the background of the template image and the marks or text printed on the template image. As part of step 306, IGS 100 may also extract information (e.g., text, numbers, etc.) that may be associated with each image placement region that identifies the candidate image to be placed in that image placement region. IGS 100 may also determine meta-data associated with one or more images in step 306.

Several other techniques may also be used to identify image placement regions and other information from the template image. Examples of such techniques have been described in the following references, the entire contents of which are herein incorporated by reference for all purposes:

(1) “Pattern Classification and Scene Analysis”, Richard Duda and Peter Hart, John Wiley & Sons Inc., 1973, pp. 276-284, 305-308; and

(2) A. Del Bimbo, S. Santini, and J. L. C. Sanz. “OCR from poor quality images by deformation of object shapes”, in 12^{th} IAPR International Conference on Pattern Recognition, Jerusalem, Israel, October 1994.

After determining one or more image placement regions, IGS 100 then determines a candidate digital image to be placed in each image placement region of the template image (step 308). Various different techniques may be used to identify candidate images to be placed in the image placement regions of the template image. According to one technique, if the signal received in step 302 identifies or comprises one or more candidate images, IGS 100 may randomly select images from the one or more candidate images to be placed in the one or more image placement regions on the template image. According to another technique, the temporal order or the ordinal order in which the candidate digital images are received by IGS 100 may be used to determine the images to be placed in the one or more image placement regions on the template image. Meta-data associated with the digital images may also used to determine a candidate image for each image placement region.

As described above, in certain embodiments of the present invention, for each image placement region, information identifying attributes of a candidate image to be placed in the image placement region is specified in the template image. Information associated with an image placement region and identifying an image to be placed in the image placement regions may be extracted by IGS 100 in step 306. For each image placement region, the information associated with the image placement region may then be used to identify a candidate image to be placed in that image placement region.

For example, if numbers are associated with image placement regions (e.g., templates 220 and 280 depicted in FIGS. 2B and 2F, respectively), IGS 100 may select a candidate image to be placed in a particular image placement region based upon the order in which the candidate images were received by IGS 100. For example, the first candidate image received by IGS 100 may be selected to be placed in an image placement region associated with number “1”, the second candidate image received by IGS 100 may be selected to be placed in an image placement region associated with number “2”, the third candidate image received by IGS 100 may be selected to be placed in an image placement region associated with number “3”, and so on.

According to another embodiment, temporal information associated with the candidate images may be used to place the candidate images in the image placement regions. For example, the oldest candidate image (i.e., the candidate image having the earliest time associated with it) received by IGS 100 may be selected to be placed in an image placement region associated with number “1”, the second oldest candidate image received by IGS 100 may be selected to be placed in an image placement region associated with number “2”, the third oldest candidate image received by IGS 100 may be selected to be placed in an image placement region associated with number “3”, and so on.

According to another embodiment of the present invention, text information associated with an image placement region may be used to determine a candidate image to be placed in that image placement region. For example, as depicted in FIG. 2C, an image of “John playing tennis” is to be placed in bounded region 242, an image of a “car” is to be placed in bounded region 246, and an image of a “meeting” is to be placed in bounded region 244. A candidate image identified by the image identifying information may either be provided in the signal received in step 302 or may otherwise be accessible to IGS 100.

According to an embodiment of the present invention, IGS 100 compares the image identifying information associated with an image placement region with attributes and/or information (could be part of the meta-data associated with the image) associated with the candidate images. If a match is found between a particular image identifying information associated with a particular image placement region and information and/or attributes associated with a particular candidate image, the particular candidate image is selected to be placed in the particular image placement region.

A user who generated the candidate image may configure the information and/or attributes associated with a candidate image. This information may be included in the meta-data associated with the candidate image. In alternative embodiments, various image processing techniques may be used to analyze the contents of a candidate image to determine information and attributes associated with the candidate image. For example, analysis of a particular candidate image may indicate that the image comprises a picture of a car. The information identified by the analysis may then be compared with information associated with an image placement region to determine if there is a match. For example, the text “Car” is associated with image placement region 246 in FIG. 2C. If the contents of a candidate image indicate the presence of a car, then that candidate image will be selected for placement in image placement region 246.

After identifying a candidate image to be placed in each image placement region printed on the template image, IGS 100 then composes a customized image using the identified candidate images (step 310). According to an embodiment of the present invention, the candidate images themselves may be placed in their corresponding image placement regions to generate the customized digital image. For example, the candidate images are superimposed onto their respective image placement regions in the template image to form the customized image.

In alternative embodiments of the present invention, for each image placement region, IGS 100 generates a digital copy of the candidate image identified (in step 308) to be placed in the image placement region. The digital copies are then placed in their corresponding image placement regions to generate the customized digital image. The customized image may be stored by IGS 100. Alternatively, IGS 100 may communicate the customized digital image to an output device 104 or to a system or device coupled to IGS 100, either directly or via communication network 106.

According to an embodiment of the present invention, an image (either the candidate image itself or a copy of the candidate image) may be adjusted before being placed in an image placement region. For example, if an image placement region is smaller or larger than the image to be placed in that image placement region, a scaled copy of the image may be placed in the image placement region such that the scaled copy fits inside the image placement region. Scaling may be performed in one or more dimensions. For example, if an image is to be placed in a rectangle shaped image placement region, the image may be scaled in both the horizontal and vertical dimensions to fit the rectangular image placement region. In alternative embodiments, the image may be scaled proportionally so that the image fits inside the bounding box in one dimension and is cropped along the other dimension to fit exactly in the image placement region. In yet other embodiments, the image may be cropped in both dimensions to fit the rectangular image placement region. In alternative embodiments, the image may be warped to fit the image placement region. It should be apparent that various other techniques known to those skilled in the art may be used to place images in the image placement regions.

According to an embodiment of the present invention, after the customized digital image has been composed according to step 310, links are created between the one or more images placed in the customized digital image and the original candidate images (step 312). This allows the customized digital image to be used as a user interface for retrieving the original candidate images. For example, a user may select (e.g., by using an input device) a particular image displayed in the customized digital image and retrieve the candidate image corresponding to the particular selected image.

According to an embodiment of the present invention, hypertext links are created between the images displayed in the customized digital image and the original candidate images. For example, image maps and the USEMAP attribute provided by the HTTP protocol may be used to create links between the customized digital image and the candidate images. The following code snippet generates a link between a customized digital image composed of a template image and two candidate images, one placed in a rectangle between (50,50) and (150,150) and the other placed in a rectangle between (200,50) and (300,150). The HTML map element would be as follows:

<map NAME=“clientsidemap”>

<area SHAPE=“rect” COORDS=“50,50,150,150” HREF=“image1.jpg”>
<area SHAPE=“rect” COORDS=“200,50,300,150” HREF=“image2.jpg”>

</map>
<a HREF=“cgi-bin/serverside.map”> <img SRC=“composite-image.jpg” ISMAP

USEMAP=“#clientsidemap”> </a>

As described above, the present invention provides techniques for creating a customized digital image comprising one or more candidate images, or copies thereof, based upon a template image. The template image allows the user to specify locations for placing images when composing the customized digital image. One or more image placement regions may be specified by the user on a template image as desired by the user. The user may also control the size of each image in the customized digital image using the image placement regions. The template image also allows the user to identify the candidate images to be placed in the image placement regions.

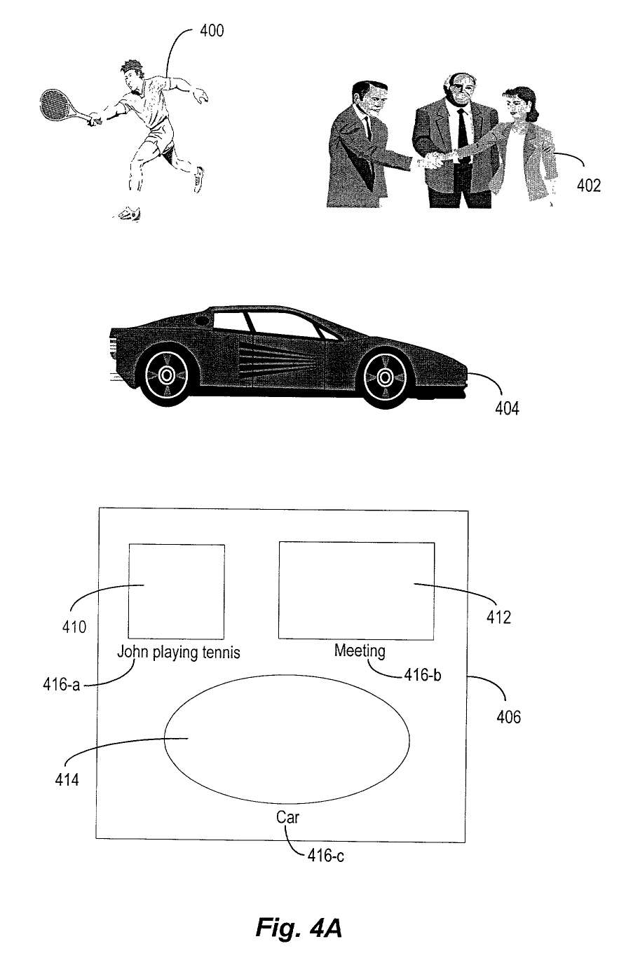

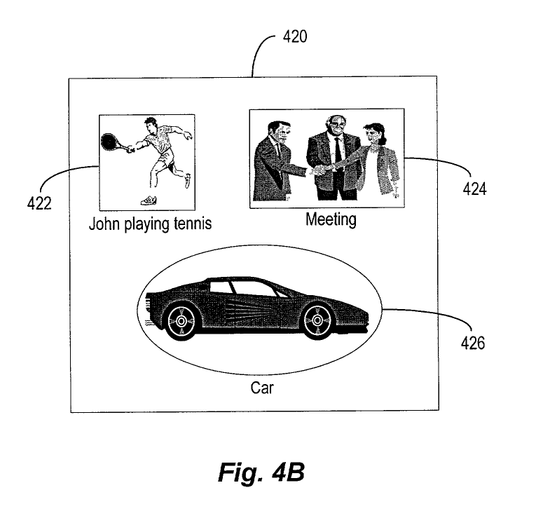

The following section describes a specific example of generating a customized digital image by applying the method depicted in FIG. 3. In this specific example, IGS 100 receives a signal requesting generation of a customized digital image (per step 302). The signal received by IGS 100 comprises four images 400, 402, 404, and 406 depicted in FIG. 4A. As depicted in FIG. 4A, the images include three candidate images 400, 402, and 404, and one template image 406. The signal may also include information or meta-data (e.g., text) that may be associated with the images and that may be used for composing the customized digital image. Candidate image 400 depicts a picture of a person “John” playing tennis, candidate image 402 depicts a picture of a meeting, and candidate image 404 depicts a picture of a car. Template image 406 comprises three bounded regions 410, 412, and 414 identifying image placement regions where the candidate images are to be placed while composing the customized image. For each bounded region, template image 406 also includes a text fragment 416 identifying a candidate image to be placed in the bounded region

IGS 100 then identifies image 406 as the template image (per step 304). As described above, various different techniques may be used to identify the template image from the plurality of images. IGS 100 then determines that template image 406 contains three image placement regions corresponding to bounded regions 410, 412, and 414 (per step 306). As part of step 306, IGS 100 also extracts text fragments 416 associated with the image placement regions.

IGS 100 then determines a candidate image to be placed in each image placement region in template image 406 (per step 308). Accordingly, IGS 100 determines that a candidate image corresponding to “John playing tennis” is to be placed in bounded region 410, a candidate image corresponding to “Meeting” is to be placed in bounded region 412, and a candidate image corresponding to “Car” is to be placed in bounded region 414. As described above, various different techniques may be used to match candidate images to specific image placement regions based upon information associated with the image placement regions and information related to the candidate images. IGS 100 then composes a customized image 420 (as depicted in FIG. 4B) by placing copies of the candidate images in their corresponding image placement regions (per step 310). As shown in FIG. 4B, the individual candidate images have been scaled to fit the bounded regions specified in template image 406.

According to an embodiment of the present invention, IGS 100 also creates links between each image displayed in customized image 420 and its original candidate image. For example, IGS 100 may create a link between image 422 displayed in customized image 420 and candidate image 400, a link between image 424 displayed in customized image 420 and candidate image 402, and a link between image 426 displayed in customized image 420 and candidate image 404. Customized image 420 can thus be used as a user interface for retrieving candidate images 400, 402, and 404. For example, a user may click on image 424 using an input device such as a mouse and in response candidate image 402 is retrieved and displayed to the user. The links thus allow a user to interact with the candidate images.

The following section describes another specific example of generating a customized digital image according to the teachings of the present invention. In this example, IGS 100 is incorporated into a digital camera that is used to generate the customized digital image. Using the digital camera, a user may capture a sequence of images. For example, the user may use the digital camera to take a photograph of John playing tennis (image 400 depicted in FIG. 4A). The user may then take a photograph of a meeting which the user attends (image 402 depicted in FIG. 4A) followed by a photograph of a car (image 404 depicted in FIG. 4A) that the user wishes to purchase.

The user may then decide to generate a customized digital image based upon the sequence of images. The user may use a writing instrument (e.g., a pen, a pencil) to draw one or more bounded regions (e.g., a square, a rectangle, an oval, a circle, etc.) on a paper page (e.g., a page taken from the user's notebook) in locations desirable to the user. For each bounded region, the user may write text information proximal to the bounded region identifying an image to be placed in the bounded region. The user may then select or activate a “template image button” on the digital camera and take a picture of the paper page (image 406 depicted in FIG. 4A). Images captured when the “template image button” is selected or activated are tagged as template images.

Image 406 is then identified by the digital camera as the template image. The digital camera then analyzes the template image to identify three image placement regions corresponding to bounded regions 410, 412, and 414. The digital camera also extracts text fragments associated with the bounded regions. The digital camera then determines that a candidate image corresponding to “John playing tennis” is to be placed in bounded region 410, a candidate image corresponding to “Meeting” is to be placed in bounded region 412, and a candidate image corresponding to “Car” is to be placed in bounded region 414. The digital camera then composes a customized image (image 420 depicted in FIG. 4B) by placing copies of the candidate images in their corresponding image placement regions. The digital camera may modify the images to fit the bounded regions specified in the template image.

The digital camera then creates links between each image displayed in the customized image and its corresponding candidate image. For example, the digital camera creates a link between image 422 displayed in customized image 420 and candidate image 400, a link between image 424 displayed in customized image 420 and candidate image 402, and a link between image 426 displayed in customized image 420 and candidate image 404. The user may then use customized digital image 420 as a user interface for retrieving candidate images 400, 402, and 404. For example, the user may click on image 424 using an input device such as a mouse and in response candidate image 402 is retrieved and displayed to the user.

It should be apparent that the examples described above are not intended to limit the scope of the present invention as recited in the claims. One of ordinary skill in the art would recognize other variations, modifications, and alternatives.

While the invention has been described with reference to digital images, other digital objects may also be used instead of the images. Techniques provided by the present invention may be used to place other types of digital objects (e.g., audio objects, video objects, and other live or static multimedia objects) in placement regions specified by a template image. Links may be created between the objects placed in the customized image and the original candidate objects such that the original candidate objects can be retrieved from the customized image. Accordingly, the scope of the present invention is not restricted to digital images.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps. The present invention may be used by users for a variety of applications including to create customized images, photo albums based upon the customized images, scrapbooks based upon the customized images, and the like.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method of generating a customized digital image, the method comprising:
receiving a first digital image;
determining one or more placement regions from the first digital image, each placement region of the one or more placement regions identifying a location on the first digital image for placing a digital image from a first set of digital images;
identifying, for each placement region of the one or more placement regions, a digital image from the first set of digital images to be placed in the placement region; and
for each placement region of the one or more placement regions, placing a digital image from the first set of digital images identified for the placement region in the placement region to generate the customized digital image.

2. The method of claim 1 wherein the first set of digital images comprises digital image copies of a second set of digital images.

3. The method of claim 2 further comprising:
creating a link between at least one digital image in the customized digital image and the corresponding digital image in the second set of digital images.

4. The method of claim 3 further comprising:
receiving a user input indicating selection of the at least one digital image in the customized digital image; and
in response to receiving the user input, retrieving the digital image corresponding to the at least one digital image from the second set of digital images.

5. The method of claim 1 wherein receiving the first digital image comprises:
scanning a paper medium on which the one or more placement regions have been indicated to generate the first digital image.

6. The method of claim 1 wherein receiving the first digital image comprises:
photographing a paper medium on which the one or more placement regions have been indicated to generate the first digital image.

7. The method of claim 1 wherein the one or more placement regions on the first digital image are indicated by one or more bounded regions.

8. The method of claim 1 wherein the one or more placement regions on the first digital image are indicated by one or more text fragments.

9. The method of claim 1 wherein the one or more placement regions on the first digital image are indicated by one or more marks.

10. The method of claim 1 wherein identifying, for each placement region of the one or more placement regions, a digital image from the first set of digital images to be placed in the placement region comprises:
determining image identification information associated with at least a first placement region of the one or more placement regions from the first digital image, the image identification information identifying an attribute of a digital image to be placed in the at least first placement region; and
identifying a first digital image from the first set of digital images to be placed in the at least first placement region based upon the image identification information associated with the at least first placement region.

11. The method of claim 10 wherein identifying the first digital image from the first set of digital images to be placed in the at least first placement region based upon the image identification information associated with the at least first placement region comprises:
identifying a digital image from the first set of digital images as the first digital image if information associated with the digital image matches the image identification information associated with the at least first placement region.

12. The method of claim 1 wherein identifying, for each placement region of the one or more placement regions, a digital image from the first set of digital images to be placed in the placement region comprises:
determining image identification information associated with at least a first placement region of the one or more placement regions from the first digital image, the image identification information identifying an attribute of a digital image to be placed in the at least first placement region;
determining a time stamp associated with each digital image in the first set of digital images; and
identifying a first digital image from the first set of digital images to be placed in the at least first placement region based upon the image identification information associated with the at least first placement region and the time stamp associated with each digital image in the first set of digital images.

13. The method of claim 1 wherein placing a digital image from the first set of digital images identified for the placement region in the placement region to generate the customized digital image comprises:
adjusting the digital image to fit the placement region.

14. The method of claim 13 wherein adjusting the digital image to fit the placement region comprises scaling the digital image to fit the placement region.

15. The method of claim 13 wherein adjusting the digital image to fit the placement region comprises cropping the digital image to fit the placement region.

16. The method of claim 1 wherein:
for each placement region of the one or more placement regions, a size of the digital image placed in the placement region is determined by a size of the placement region.

17. A method of generating a customized digital image, the method comprising:
receiving a signal comprising digital signals representative of a plurality of digital images;
determining a template image from the plurality of digital images;
determining one or more placement regions from the template image, each placement region of the one or more placement regions identifying a location on the template image for receiving a digital image from the plurality of digital images;
identifying, for each placement region of the one or more placement regions, a digital image from the plurality of digital images to be placed in the placement region; and
for each placement region of the one or more placement regions, placing a copy of a digital image from the plurality of digital images identified for the placement region in the placement region to generate the customized digital image.

18. A method of generating a customized digital image, the method comprising:
receiving a first digital image;
analyzing the first digital image to determine a first placement region on the first digital image for placing a second digital image; and
placing the second digital image in the first placement region on the first digital image to generate the customized digital image.

19. The method of claim 18 wherein the second digital image is a copy of a third digital image.

20. The method of claim 19 further comprising:
creating a link between the second digital image placed in the first placement region in the first digital image and the third digital image.

21. The method of claim 20 further comprising:
receiving a user input indicating selection of the second digital image placed in the first placement region in the customized image; and
in response to receiving the user input, retrieving the third digital image.

22. The method of claim 18 wherein receiving the second digital image comprises:
scanning a paper medium on which the first placement region is marked to generate the first digital image.

23. The method of claim 18 wherein receiving the first digital image comprises:
photographing a paper medium on which the first placement region is marked to generate the first digital image.

24. A method of generating a customized digital image using a digital camera, the method comprising:
capturing one or more images using the digital camera;
capturing a template image by scanning a paper medium;
determining one or more placement regions from the template image, each placement region of the one or more placement regions identifying a location on the template image for placing an image from the one or more images captured using the digital camera;
identifying, for each placement region of the one or more placement regions, an image from the one or more images to be placed in the placement region; and
for each placement region of the one or more placement regions, placing a copy of an image from the one or more images identified for the placement region in the placement region to generate the customized digital image.

25. A method of generating a customized digital image using a digital camera, the method comprising:
using the digital camera to capture one or more images;
using the digital camera to capture a template image, the template image comprising one or more bounded regions, each bounded region of the one or more bounded regions identifying a location on the template image for placing an image of the one or more images captured using the digital camera; and
obtaining the customized image from the digital camera, wherein the customized digital image is generated by placing a copy of at least one image from the one or more images in at least one bounded region on the template image.

26. The method of claim 25 wherein using the digital camera to capture the template image comprises:
imprinting the one or more bounded regions on a paper medium;
selecting a button on the digital camera; and
using the digital camera to capture an image of the paper medium while the button the digital camera is selected.

27. A system for generating a customized digital image, the system comprising:
an input module; and
a processing module;
wherein the input module is configured to receive a first digital image; and
wherein the processing module is configured to:
determine one or more placement regions from the first digital image, each placement region of the one or more placement regions identifying a location on the first digital image for placing a digital image from a first set of digital images;
identify, for each placement region of the one or more placement regions, a digital image from the first set of digital images to be placed in the placement region; and
for each placement region of the one or more placement regions, place a digital image from the first set of digital images identified for the placement region in the placement region to generate the customized digital image.

28. The system of claim 27 wherein the first set of digital images comprises digital image copies of a second set of digital images.

29. The system of claim 28 wherein the processing module is further configured to create a link between at least one digital image in the customized digital image and the corresponding digital image in the second set of digital images.

30. The system of claim 29 wherein:
the input module is configured to receive a user input indicating selection of the at least one digital image in the customized digital image; and
the processing module is configured to, in response to the user input, retrieve the digital image corresponding to the at least one digital image from the second set of digital images.

31. The system of claim 27 further comprising a scanner configured to scan a paper medium on which the one or more placement regions have been indicated to generate the first digital image.

32. The system of claim 27 further comprising an image capture module configured to photograph a paper medium on which the one or more placement regions have been indicated to generate the first digital image.

33. The system of claim 27 wherein the one or more placement regions on the first digital image are indicated by one or more bounded regions.

34. The system of claim 27 wherein the one or more placement regions on the first digital image are indicated by using one or more text fragments.

35. The system of claim 27 wherein the one or more placement regions on the first digital image are indicated by one or more marks.

36. The system of claim 27 wherein in order to identify, for each placement region of the one or more placement regions, a digital image from the first set of digital images to be placed in the placement region, the processing module is configured to:
determine image identification information associated with at least a first placement region of the one or more placement regions from the first digital image, the image identification information identifying an attribute of a digital image to be placed in the at least first placement region; and
identify a first digital image from the first set of digital images to be placed in the at least first placement region based upon the image identification information associated with the at least first placement region.

37. The system of claim 36 wherein in order to identify the first digital image from the first set of digital images to be placed in the at least first placement region based upon the image identification information associated with the at least first placement region, the processing module is configured to:
identify a digital image from the first set of digital images as the first digital image if information associated with the digital image matches the image identification information associated with the at least first placement region.

38. The system of claim 27 wherein in order to identify, for each placement region of the one or more placement regions, a digital image from the first set of digital images to be placed in the placement region, the processing module is configured to:
determine image identification information associated with at least a first placement region of the one or more placement regions from the first digital image, the image identification information identifying an attribute of a digital image to be placed in the at least first placement region;
determine a time stamp associated with each digital image in the first set of digital images; and
identify a first digital image from the first set of digital images to be placed in the at least first placement region based upon the image identification information associated with the at least first placement region and the time stamp associated with each digital image in the first set of digital images.

39. The system of claim 27 wherein the processing module is configured to place a digital image from the first set of digital images identified for the placement region in the placement region to generate the customized digital image by adjusting the digital image to fit the placement region.

40. The system of claim 39 wherein the processing module adjusts the digital image to fit the placement region by scaling the digital image to fit the placement region.

41. The system of claim 39 wherein the processing module adjusts the digital image to fit the placement region by cropping the digital image to fit the placement region.

42. The system of claim 27 wherein:
for each placement region of the one or more placement regions, a size of the digital image placed in the placement region is determined by a size of the placement region.

43. A digital camera that incorporates the system of claim 27.

44. A copying machine that incorporates the system of claim 27.

45. A system for generating a customized digital image, the system comprising:
a processor; and
a memory coupled to the processor, the memory configured to store a plurality of code modules for execution by the processor, the plurality of code modules including:
a code module for receiving a signal comprising digital signals representative of a plurality of digital images;
a code module for determining a template image from the plurality of digital images;
a code module for determining one or more placement regions from the template image, each placement region of the one or more placement regions identifying a location on the template image for receiving a digital image from the plurality of digital images;
a code module for identifying, for each placement region of the one or more placement regions, a digital image from the plurality of digital images to be placed in the placement region; and
a code module for placing, for each placement region of the one or more placement regions, a copy of a digital image from the plurality of digital images identified for the placement region in the placement region to generate the customized digital image.

46. A system for generating a customized digital image, the system comprising:
a processor; and
a memory for storing a program;
wherein the processor is operative with the program to:
receive a first digital image;
receive a second digital image;
analyze the second digital image to determine a first placement region on the second digital image for placing the first digital image; and
place the first digital image in the first placement region on the second digital image to generate the customized digital image.

47. The system of claim 46 wherein the first digital image is a copy of a third digital image.

48. The system of claim 47 wherein the processor is operative with said program to create a link between the first digital image placed in the first placement region in the second digital image and the third digital image.

49. The system of claim 48 wherein the processor is operative with said program to:
receive a user input indicating selection of the first digital image placed in the first placement region in the customized image; and
in response to receiving the user input, to retrieve the third digital image.

50. The system of claim 46 wherein the processor is operative with said program to scan a paper medium on which the first placement region is marked to generate the first digital image.

51. The system of claim 46 wherein the processor is operative with said program to photograph a paper medium on which the first placement region is marked to generate the first digital image.

52. A digital camera comprising:
a processor; and
a memory for storing a program;
wherein the processor is operative with the program to:
receive one or more images;
receive a template image;
determine one or more placement regions from the template image, each placement region of the one or more placement regions identifying a location on the template image for placing an image from the one or more images captured using the digital camera;
identify, for each placement region of the one or more placement regions, an image from the one or more images to be placed in the placement region; and
for each placement region of the one or more placement regions, place a copy of an image from the one or more images identified for the placement region in the placement region to generate the customized digital image.

53. The digital camera of claim 52 further comprising a first button which when selected indicates that an image received by the digital camera is a template image.

54. An apparatus for generating a customized digital image, the apparatus comprising:
a processor; and
a memory for storing a program;
wherein the processor is operative with the program to:
receive a first image;
determine a first placement region and a second placement region from the first image; and
compose the customized digital image by placing a second image in the first placement region on the first image and by placing a third image in the second placement region on the first image.

55. A digital camera that incorporates the apparatus of claim 54.

56. A copier machine that incorporates the apparatus of claim 54.

57. A computer program product stored on a computer readable storage medium for generating a customized digital image, the computer program comprising:
code for receiving a first digital image;
code for determining one or more placement regions from the first digital image, each placement region of the one or more placement regions identifying a location on the first digital image for placing a digital image from a first set of digital images;
code for identifying, for each placement region of the one or more placement regions, a digital image from the first set of digital images to be placed in the placement region; and
for each placement region of the one or more placement regions, code for placing a digital image from the first set of digital images identified for the placement region in the placement region to generate the customized digital image.

58. The computer program product of claim 57 wherein the first set of digital images comprises digital image copies of a second set of digital images, and the computer program product further comprises code for creating a link between at least one digital image in the customized digital image and the corresponding digital image in the second set of digital images.

59. The computer program product of claim 58 further comprising:
code for receiving a user input indicating selection of the at least one digital image in the customized digital image; and
in response to receiving the user input, code for retrieving the digital image corresponding to the at least one digital image from the second set of digital images.

60. The computer program product of claim 57 wherein the code for receiving the first digital image comprises:
code for scanning a paper medium on which the one or more placement regions have been indicated to generate the first digital image.

61. The computer program product of claim 57 wherein the code for receiving the first digital image comprises:
code for photographing a paper medium on which the one or more placement regions have been indicated to generate the first digital image.

62. The computer program product of claim 57 wherein the one or more placement regions on the first digital image are indicated by one or more bounded regions.

63. The computer program product of claim 57 wherein the one or more placement regions on the first digital image are indicated by one or more text fragments.

64. The computer program product of claim 57 wherein the one or more placement regions on the first digital image are indicated by one or more marks.

65. The computer program product of claim 57 wherein the code for identifying, for each placement region of the one or more placement regions, a digital image from the first set of digital images to be placed in the placement region comprises:
code for determining image identification information associated with at least a first placement region of the one or more placement regions from the first digital image, the image identification information identifying an attribute of a digital image to be placed in the at least first placement region; and
code for identifying a first digital image from the first set of digital images to be placed in the at least first placement region based upon the image identification information associated with the at least first placement region.

66. The computer program product of claim 65 wherein the code for identifying the first digital image from the first set of digital images to be placed in the at least first placement region based upon the image identification information associated with the at, least first placement region comprises:
code for identifying a digital image from the first set of digital images as the first digital image if information associated with the digital image matches the image identification information associated with the at least first placement region.

67. The computer program product of claim 57 wherein the code for identifying, for each placement region of the one or more placement regions, a digital image from the first set of digital images to be placed in the placement region comprises:
code for determining image identification information associated with at least a first placement region of the one or more placement regions from the first digital image, the image identification information identifying an attribute of a digital image to be placed in the at least first placement region;
code for determining a time stamp associated with each digital image in the first set of digital images; and
code for identifying a first digital image from the first set of digital images to be placed in the at least first placement region based upon the image identification information associated with the at least first placement region and the time stamp associated with each digital image in the first set of digital images.

68. The computer program product of claim 57 wherein:
for each placement region of the one or more placement regions, a size of the digital image placed in the placement region is determined by a size of the placement region; and
the code for placing a digital image from the first set of digital images identified for the placement region in the placement region to generate the customized digital image comprises code for adjusting the digital image to fit the placement region.

69. The computer program product of claim 68 wherein the code for adjusting the digital image to fit the placement region comprises code for scaling the digital image to fit the placement region.

70. The computer program product of claim 68 wherein the code for adjusting the digital image to fit the placement region comprises code for cropping the digital image to fit the placement region.

71. A computer program product stored on a computer readable storage medium for generating a customized digital image, the computer program product comprising:
code for receiving a signal comprising digital signals representative of a plurality of digital images;
code for determining a template image from the plurality of digital images;
code for determining one or more placement regions from the template image, each placement region of the one or more placement regions identifying a location on the template image for receiving a digital image from the plurality of digital images;
code for identifying, for each placement region of the one or more placement regions, a digital image from the plurality of digital images to be placed in the placement region; and
for each placement region of the one or more placement regions, code for placing a copy of a digital image from the plurality of digital images identified for the placement region in the placement region to generate the customized digital image.

72. A computer program product stored on a computer readable storage medium for generating a customized digital image, the computer program product comprising:
code for receiving a first digital image;
code for analyzing the first digital image to determine a first placement region on the first digital image for placing a second digital image; and
code for placing the second digital image in the first placement region on the first digital image to generate the customized digital image.

73. The computer program product of claim 72 wherein the second digital image is a copy of a third digital image.

74. The computer program product of claim 73 further comprising:
code for creating a link between the second digital image placed in the first placement region in the first digital image and the third digital image.

75. The computer program product of claim 74 further comprising:
code for receiving a user input indicating selection of the second digital image placed in the first placement region in the customized image; and
in response to receiving the user input, code for retrieving the third digital image.

76. The computer program product of claim 72 wherein the code for receiving the second digital image comprises:
code for scanning a paper medium on which the first placement region is marked to generate the first digital image.

77. The computer program product of claim 72 wherein the code for receiving the first digital image comprises:
code for photographing a paper medium on which the first placement region is marked to generate the first digital image.
